(19) United States
(12) Patent Application Publication
(10) Pub. No.: US 2002/0138402 A1
(43) Pub. Date: Sep. 26, 2002

(54) Agents, system and method for dynamic pricing in a reputation-brokered, agent-mediated marketplace

(76) Inventors: Giorgos Zacharia, Cambridge, MA (US); Theodoros Evgeniou, Halkidiki (GR)

Correspondence Address: WOLF GREENFIELD & SACKS, PC, FEDERAL RESERVE PLAZA, 600 ATLANTIC AVENUE, BOSTON, MA, 02210-2211, US

(21) Appl. No.: 09/948,082

(22) Filed: Sep. 6, 2001

Related U.S. Application Data
(60) Provisional application No. 60/230,355, filed on Sep. 6, 2000.
(60) Provisional application No. 60/230,273, filed on Sep. 6, 2000.

(51) Int. Cl. G06F 17/60

(52) U.S. Cl. 705/37

(57) ABSTRACT

Agent-mediated commerce method and system, and agents for use therein. Seller agents may offer services at prices that vary over time, based on past experiences. Buyer agents may be configured by their users according to time and constraints, budget and the importance of a specific task. Buyer agents try, probabilistically, to maximize their owners' utilities (in part, by estimating the expected performance of each seller based on the reputation of that seller in the relevant marketplace. Buying agents may reveal only their time constraints and descriptions of the tasks (services) desired to the sellers. Seller agents bid for the offered tasks and base their bids at least partly on their owners' reputations, their time availability, the difficulty of the task and the current demand on the marketplace. Seller reputations are updated in a collaborative fashion based on seller performance. Seller agents employ dynamic pricing mechanisms, including specifically profit maximizing reputation followers.

### RELATED APPLICATIONS

This application claims priority under 35 U.S.C. 119(e) to copending U.S. provisional patent application 60/230,355 filed Sep 6, 2000, titled “Dynamic Pricing in a Reputation-Brokered Agent-Mediated Knowledge Marketplace;” and 60/230,273, also filed Sep. 6, 2000, titled “Dynamic Pricing in a Reputation-Brokered Agent-Mediated Knowledge Marketplace,” both of which are hereby incorporated by reference in their entireties.

This application is also related to a series of commonly-owned U.S. patent applications relating to automating reputation mechanisms for enhancing electronic commerce, including: “Method and System for Ascribing a Reputation to an Entity as a Rater of Other Entities” by Giorgos Zacharia and Dmitry Tkach, Ser. No. 09/710,008; “Method and System for Ascribing a Reputation to an Entity from the Perspective of Another Entity” by Giorgos Zacharia, Ser. No. 09/709,989; “System and Method for Estimating the Impacts of Multiple Ratings on a Result” by Giorgos Zacharia, Ser. No. 09/710,498; “System and Method for Ascribing a Reputation to an Entity” by Giorgos Zacharia, Ser. No. 09/710,011 and “System and Method for Recursively Estimating a Reputation of an Entity” by Giorgos Zacharia, Ser. No. 09/710,289, each of said applications filed on Nov. 10, 2000; and each of which is herein incorporated by reference in its entirety.

### FIELD OF THE INVENTION

This invention relates to electronic marketplaces where products and services are bought and sold. In particular, it relates to agent-mediated marketplaces wherein buyers and sellers act through software agents to effectuate transactions and pricing may be altered dynamically by sellers in response to market conditions including the parties' reputations.

### BACKGROUND

The emergence of the Internet and other large networks has increased both the number and kinds of electronic exchanges between entities. As used herein, an electronic exchange is any exchange between two or more entities over an electronic network (i.e., not in person) such as, for example, a voice communications network (e.g., POTS or PBX) or a data communications network (e.g., LAN or the Internet) or a voice-and-data communications network (e.g., voice-over-IP network). Electronic exchanges may include electronic business transactions and electronic communications. Such electronic business transactions may include the negotiation and closing of a sale of goods or services, including solicitation of customers, making an offer and accepting an offer. For example, in consumer-to-consumer electronic marketplaces (e.g., the eBay, OnSale, Yahoo and Amazon marketplaces found on the global Internet at the following respective URLs: www.ebay.com, www.onsale.com, www.yahoo.com, and www.amazon.com) entities may transact for the sale and purchase of goods or services.

Electronic communications also may include communications in on-line communities such as mailing lists, news groups, or web-based message boards and chat rooms, where a variety of sensitive personal information may be exchanged, including health-related data, financial investment data, help and advise on research and technology-related issues, or even information about political issues. As referred to herein, an entity may be a person or an electronic agent (e.g., a software agent). Such a person may act as an individual (i.e., on the person's own behalf) or as a representative (e.g., officer or agent) of a corporation, partnership, agency, organization, or other group. An electronic agent may act as an agent of an individual, corporation, partnership, agency, organization, or other group.

In many electronic exchanges, an entity's identity may be anonymous to another entity. This anonymity raises several issues regarding trust and deception in connection to these exchanges. For example, an anonymous entity selling goods on-line may misrepresent the condition or worth of a good to a buyer without suffering a loss of reputation, business or other adverse effect, due to the entity's anonymity.

One solution to the problems regarding trust and deception is to provide a reputation mechanism to determine and maintain a reputation or reliability rating of an entity. Typically, a reputation mechanism is intended to provide an indication of how reliable an entity is, i.e., how truly its actions correspond to its representations, based on feedback by other entities that have conducted an electronic exchange with the entity. Such feedback typically is provided by another entity in the form of evaluations in a numerical (e.g., 1-5) or Boolean (e.g., good or bad) form. In some reputation mechanisms, an average of the evaluations provided by other entities are calculated to produce the reputation rating of the entity. Such reputation mechanisms typically represent the reputation of an entity with a scalar value.

Typical reputation mechanisms suffer from susceptibility to frauds or deceptions. For example, a first typical fraud occurs when an anonymous entity, after developing a poor reputation over time in an on-line community, reenters the community with a new anonymous identity (i.e., on-line name), thereby starting anew with a higher reputation than the entity's already earned poor reputation. A second typical fraud, to which typical reputation mechanisms are susceptible, occurs when two or more entities collude to provide high ratings for each other on a relatively frequent basis, such that the reputations of these entities are thereby artificially inflated.

Two reputation mechanisms that solve these two problems, Sporas and Histos, are disclosed in “Collaborative Reputation Mechanisms for On-line Communities” by Giorgos Zacharia, submitted to the Program of Media Arts and Sciences, Massachusetts Institute of Technology, Cambridge, Mass. published September, 1999 (hereinafter “the Zacharia thesis”), the contents of which are herein incorporated by reference.

Sporas is a reputation mechanism for loosely-connected communities (i.e., one in which many entities may not have had an electronic exchange with one another and thus not have rated one another.) According to the Sporas technique, a reputation may be calculated for an entity by applying the following equation:

$$Equation 1 : {R}_{i} = {R}_{i - 1} + \frac{1}{C} \cdot damp ( {R}_{i - 1} ) {R}_{i}^{other} ( {W}_{i} - {E}_{i} ) ,$$

where Rᵢ₋₁ is the initial reputation of the entity, C is an effective number of ratings, 1/C is the change rate factor, named as such because it impacts the rate at which the reputation changes, damp (Rᵢ₋₁) is a damping function, Rᵢ^{other} is the reputation of another entity providing the rating, Wᵢ is the rating of the entity provided by the other entity, Eᵢ is the expected value of the rating and Rᵢ is the reputation of the entity.

Zacharia discloses that the damping function may be calculated by applying the following equation:

$$Equation 2 : damp ( {R}_{i - 1} ) = 1 - \frac{1}{1 + {e}^{\frac{- ( {R}_{i - 1} - D )}{a}}} ,$$

where D is the size of the range of allowed reputation values and α is a so-called “acceleration” factor. The acceleration factor is named as such because its value controls a rate at which an entity's reputation changes. The Zacharia thesis further discloses that an expected rating, Eᵢ can be calculated from the following equation:

$$Equation 3 : {E}_{i} = \frac{{R}_{i - 1}}{D} .$$

(Throughout this application, if a value represented by a symbol from a current equation was described in connection with a previously-described equation, the description of the value will not be repeated for the current equation.)

The Sporas technique implements an entity reputation mechanism based on the following principles. First, new entities start with a minimum reputation value, and build-up their reputations as a result of their activities on the system. For example, if a reputation mechanism has a rating range from 1 to 100, then an entity may start with an initial reputation value, R₀, of 1. By starting with the minimum reputation value, Sporas reduces the incentive to, and effectively eliminates, that ability of an entity with a low reputation to improve the entity's reputation by reentering the system as a new anonymous identity.

Second, the reputation of an entity never falls below the reputation of a new entity. This may be ensured by applying equation 1 above. This second principle also reduces the incentive, and effectively prevents, an entity with a low reputation from reentering the system as a new anonymous entity.

Third, after each electronic exchange, the reputations of each of the two or more entities involved are updated according to the feedback or ratings provided by the other entities, where the feedback or ratings represent the demonstrated trustworthiness of the two or more entities in the latest exchange. For example, referring to Equation 1 above, the ratee reputation Rᵢ of an entity is updated for each new rating, Wᵢ.

Fourth, two entities may rate each other only once within a predetermined number of consecutive ratings. If two entities exchange more than once, then, for each entity, the reputation mechanism only applies the most recently submitted rating to determine the reputation of the rated entity. This fourth principle prevents two or more entities from fraudulently inflating their reputations, as describe above, by frequently rating each other with artificially high ratings.

Fifth, entities with very high reputation values experience smaller rating changes after each update. This fifth principle is implemented by the damping function, damp(Rᵢ₋₁), of Equations 1 and 2 above. The damping function increases as the ratee reputation of the rated entity decreases, and decreases as the ratee reputation of the rated entity increases. Thus, a high reputation is less susceptible to change by a single poor rating provided by another entity.

Sixth, the reputation mechanism adapts to changes in an entity's behavior. For example, a reputation may be discounted over time so that the most recent ratings of an entity have more weight in determining the ratee reputation of the entity. For example, in Equation 1, above, ratings are discounted over time by limiting the effective number of ratings considered, C.

The Sporas reputation mechanism also weights the reputation of a rated entity according to the reputation, R^{other}, of another entity providing the rating, where this reputation of the other entity may be determined by applying Equation 1. Therefore, ratings from entities having relatively higher reputations have more of an impact on the reputation of the rated entity than ratings from entities having relatively lower reputations.

As described in the Zacharia thesis, Histos is a reputation mechanism better-suited for a highly-connected community, where entities have provided ratings for a significant number of the other entities. Histos determines a personalized reputation of a first entity from a perspective of a particular entity.

Histos represents the principle that a person or entity is more likely to trust the opinion of another person or entity with whom she is familiar than trust the opinion of another person or entity who she does not know. Unlike Sporas, a reputation of first entity in Histos depends on the second entity from whose perspective the determination is made, and other ratings of the second entity provided by other users in an on-line community or population.

FIG. 1 is a block diagram illustrating a representation of an on-line community or population 300 of entities A₁-A₁₁ interconnected by several rating links, including rating links 302, 303, 304, 306, 308 and 310. Each rating link indicates a rating of a rated entity (i.e., a ratee) by a rating entity (i.e., a rater) with an arrowhead pointing from the rating entity to the rated entity. As used herein, a ratee is an entity in a position of being rated by one or more other entities, and a rater is an entity in a position of rating one or more other entities. For example, rating link 302 represents a rating of 0.8 for ratee A₃ by rater A₁, and rating link 303 represents a rating of 0.9 for ratee Al by rater A₃.

Although in FIG. 1, each rating link only indicates a single rating, it is possible that an entity has provided more than one rating for another entity. The Zacharia reference discloses that if an entity has provided more than rating for another entity, the most recent rating should be selected to determine a personalized reputation of a first entity from the perspective of a second entity.

A rating may be multi-dimensional, also, rather than one-dimensional. For example, dimensions may include promptness of shipment, correspondence between advertised and delivered quality of goods, warranty terms, and so forth.

More complete disclosure on reputation mechanisms is contained in the above-referenced patent applications. Suffice it to say at this juncture that the impact of reputation on transactions in marketplaces has been noted and studied for some time. However, the majority of such study has focussed on transactions involving the sale of goods. The sale of services raises additional complications. A buyer, for example, in choosing between two potential sellers, may be willing to pay a higher price to the seller (service provider) who has a reputation for more timely completion of tasks, more experience on complicated projects or better service after the task is completed. And if the sellers' prices are equal, the buyer will always prefer that seller. However, if the price difference exceeds some threshold and that seller has the higher price, the buyer may choose another seller. Competency and performance of the seller are thus of great concern to the buyer. Buyers may be viewed as users with questions and sellers as users with answers. In one regard, it is reputation that answers many of the questions, particularly comparative analysis of reputation as between two or more would-be sellers. Reputation is thus a potentially more important factor in a service-provider's profitability than it is for a goods merchant, both in conventional markets and for electronic commerce. A service provider with a strong reputation can close more sales at higher prices (up to some limits) than can a service provider with a significantly lower reputation. Thus, service providers often conduct customer satisfaction surveys in order to assess their reputations and find ways to improve them. A service provider that receives a high rating from customers may feel comfortable raising its prices, while a service provider who receives low ratings may feel compelled to lower its prices to generate more business. Services, thus, are not as fungible as goods and the profitability of a service merchant may be more dependent on its reputation than is the profitability of a goods merchant. Automating these principles is not a simple task.

For example, there has been a project running for several years at the MIT Media Laboratory in Cambridge, Mass., called Kasbah. In Kasbah, a user wanting to buy or sell a good creates a software agent, gives it some strategic direction, and sends it off into the agent marketplace, a realm in which parties' agents are allowed to interact. This marketplace typically exists on a computer network, which may be a private network or a public network such as the Internet. Kasbah agents proactively seek out potential buyers or sellers (that is, the agents of potential buyers or sellers) and negotiate with them on their creator's behalf. Individuals and entities trying to transact business in this marketplace are assigned reputation values based upon past behaviors or based upon entry-level values if they have no history. In Kasbah, the reputation values of the individuals or entities trying to buy or sell goods or services are major parameters affecting the behavior of the buying, selling or finding agents in this system. More so than for most goods, the pricing of services in a conventional market is often a function of a current state of supply and demand. Goods may sit in a warehouse until demand increases and a merchant may incur some inventory financing charges, but if a service worker is idle for a day because there is no task for him to complete for a customer, the potential revenue for that day is forever lost. That is, time is a perishable resource for service providers. Service providers thus strive to keep their workers as busy as possible, lowering prices when necessary to do so. A buyer who can be patient and wait for a particular provider to be idle may be able to hire that service provider at a low price, even if the seller (service provider) has an excellent reputation.

A version of Kasbah, which was implemented using a so-called MarketMaker infrastructure, allows users to trade intangibles such as services. However, in Kasbah, price negotiation is based on a limited number of predefined negotiation strategies provided by the system. Agents created with these strategies cannot adjust a negotiation behavior according to the market conditions and the user has to make sure that his/her/its price ranges are close to the market prices.

A need therefore exists for an electronic commerce system providing greater flexibility in adaptive pricing and price negotiation strategies. In addition, it would be desirable to have software agents that automate the task of monitoring market conditions for their users. A further need is to replace predefined time-varying price functions with adaptive pricing for sellers and utility evaluation functions for buyers. (The concept of utility enters economic analysis typically via the concept of a utility function which itself is just a mathematical representation of an individual's preferences over alternative bundles of consumption goods (or, more generally, over goods, services, and leisure). If the individual's preferences are complete, reflexive, transitive, and continuous, then they can be represented by a continuous utility function. In this sense, utility itself is an almost empty concept: It is just a number associated with some consumption bundle. A general treatment of the existence of an utility function is due to Debreu, G., “Continuity properties of paretian utility,”

International Economic Review, 5, 285-293 (1964). “Expected utility” is an axiomatic extension of the ordinal concept of utility to uncertain payoffs. ) Investigators previously have researched adaptive pricing agents and have shown that with minimally intelligent agents economically efficient equilibria can be achieved without the agents knowing each other's strategy or the market conditions from a macroscopic level. It has also been shown that in a marketplace with quality differentiation and quality sensitive users, stable price equilibria can be achieved. However, this has only been demonstrated when the quality of sellers is stationary and sellers can sell their information goods to multiple buyers at the same time. Thus a need exists for a system and method by which intelligent agents can be constructed and operated to permit buyers and sellers to have dynamically changing reputations. Preferably, sellers are engaged to buyers one at a time.

### SUMMARY OF THE INVENTION

In response to recognition of these needs, there is provided a method and system, and agents for use in that method and system, for time-varying pricing of transactions between buyers and sellers, particularly as related (but not limited) to transactions for services. That is, seller agents may offer services at prices that vary over time, based on past experiences. Buyer agents may be configured by their users according to time and constraints, budget and the importance of a specific task (also called a job, project or contract). The buyer agents created this way try, probabilistically, to maximize their owners'utilities. They do so, in part, by estimating the expected performance of each seller based on the reputation of that seller in the relevant marketplace (i.e., a seller could have different reputations in different marketplaces). The buying agents may reveal only their time constraints and descriptions of the tasks (services) desired to the sellers, in order to achieve their goal. The budget constraints and the importance of the task for the buyer are not revealed since they reduce the negotiating power of the buyer.

Seller (selling) agents respond to buying (buyer) agents by bidding on behalf of their owners for the available (i.e., proposed or offered) tasks. The bids of the sellers may be based in part on their owners' reputations, their time availability, the difficulty of the task and the current demand on the marketplace, or some one of such factors or other combination thereof, with or without other not-listed factors. Preferably, the seller reputations are updated in this marketplace in a collaborative fashion (i.e., with all or most buyers contributing their evaluations), based on the performance of the sellers in their delegated tasks (i.e., the tasks required in the contracts they win from buyers).

Beginner sellers may be undervalued until their reputation values are raised over time, through positive performance and earning better reputation values, until their reputation ratings approach their actual abilities and performance. To address this situation, and to compensate for performance variability of sellers, seller agents employ dynamic pricing mechanisms. Dynamic pricing allows a seller to set its price as efficiently as possible, by considering the current reputations of all sellers.

Various novel aspects of buyer agents, seller agents and an agent-mediated, reputation-brokered marketplace (which may or may not be an electronic commerce marketplace) are described and form separate aspects of what we regard as our invention. The various aspects of the invention recited in this portion of the document are not intended to be exclusive or exhaustive in that respect. For example, elements that we discuss herein may be combined in additional ways from those set out in this summary.

Accordingly, it is a first aspect of the invention to provide a seller's agent for use in an agent-mediated marketplace, the seller's agent using a reputation follower strategy to set a bid price for responding to a buyer's offer to purchase, and responsive to seller reputation information. The reputation information may include reputation values for all sellers bidding in response to the buyer's offer. The reputation follower strategy may (preferably) be a profit maximizing reputation follower strategy as described below. As a possibility, but not a requirement, in response to wining a contract with a buyer' agent, the seller's agent may evaluate its resulting abilities and withdraw from bidding on any further buyers' offers it will not be able to satisfy as a result of the contractual demands on the seller until the contract has been completed and the seller's associated resources are again available.

Another aspect of the invention is a method for a seller's agent to formulate a bid price in response to a buyer's offer to purchase via an agent-mediated marketplace. The seller's agent examines the buyer's offer and receives information about the seller's reputation and the reputations of other sellers of services requested by the buyer. Based on the buyer's offer, the reputation information, and the seller's history of success, the seller's agent formulates a bid price and conveys the bid price to the buyer. The bid formulation may be based on a reputation follower or profit maximizing reputation follower strategy.

Still another aspect of the invention is a system for effecting electronic contracts between buyers and sellers. The system includes a plurality of seller agents, a plurality of buyer agents, a marketplace server, and a seller reputation data source. The buyer agents place on the marketplace server offers to purchase; the seller agents evaluate the offers to purchase and selective bid to meet an offer when a seller has the ability to do so, a price included in the bid being based at least in part on a seller reputation value obtained from the seller reputation data source. In such a system, buying agents may evaluate bids from sellers at least in part in consideration of seller reputation values from the seller reputation data source, a seller's price bid and an importance the buying attaches to the purchase. The selling agents use a reputation follower strategy, preferably a profit-maximizing reputation follower strategy, to set a bid price.

The features and advantages of the systems and methods described above and other features and advantages of the systems and methods will be more readily understood and appreciated from the detailed description below, which should be read together with the accompanying drawing figures.

### BRIEF DESCRIPTION OF THE DRAWINGS

In the drawings:

FIG. 1 is a block diagram illustrating a representation of an on-line community, showing rating links between various entities;

FIG. 2 is a diagrammatic illustration of a system platform for an agent-mediated marketplace for dynamic pricing in response to reputation changes;

FIG. 3 is a graph of the seller's available offer space as a function of the seller's reputation;

FIG. 4 is a graph showing the results of a simulation of the performance of three types of seller agents in the absence of competition among them;

FIG. 5 is a graph showing the results of a simulation of the performance of three types of seller agents in the presence of competition among them;

FIG. 6 is a graph showing the results of a simulation to compare the profits achieved by Reputation Follower seller agents with the profits achieved by Derivative Follower seller agents in unemployment;

FIG. 7 is a graph showing the results of a simulation of the performance of three types of seller agents in the absence of competition among them;

FIG. 8 is a graph showing the results of a simulation of the performance of three types of seller agents in the presence of competition among them;

FIG. 9 is a graph showing the results of a simulation to compare the profits achieved by Reputation Follower seller agents with the profits achieved by Derivative Follower seller agents in overemployment;

FIGS. 10-13 are charts listing experimental results obtained with so-called Optimal Sellers as described herein;

FIG. 14 is a table which sets forth the logic for a Profit Maximizing Reputation Follower selling agent as described herein, for determining how to incrementally alter its bid pricing; and

FIGS. 15-17 are charts listing experimental results obtained with agent logic of FIG. 14.

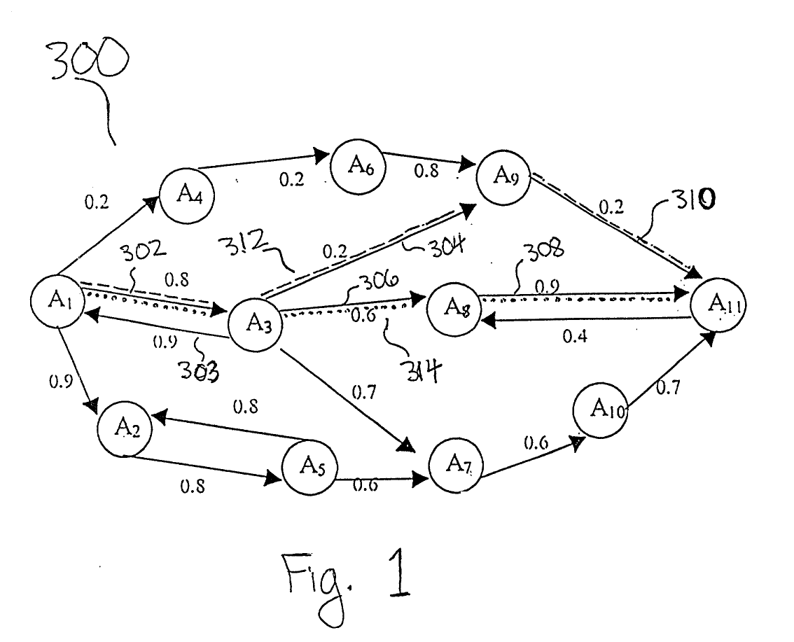

### DETAILED DESCRIPTION OF THE INVENTION

Described below is a method and system, and agents for use in that method and system, for time-varying pricing of transactions between buyers and sellers, particularly as related to transactions for services. That is, sellers may offer services at prices that vary over time, based on past experiences. Although dynamic pricing is described below primarily in connection with pricing of transactions on electronic exchanges, such pricing may be applied to any of a variety of situations, regardless of whether the transaction is on an electronic exchange. Solely for purposes of illustration, as an example and not to be limiting, the dynamic pricing agents and system will be shown in the context of an electronic marketplace accessed by users via the global Internet.

The ratings used by the dynamic pricing mechanisms discussed herein may come from any usable source or system, including, but not limited to, the systems disclosed in any of the above-referenced patent applications.

In the context of an agent-mediated marketplace wherein the present invention may be used, buyers are users who need certain goods or services that sellers can provide. In particular, in a marketplace for buying and selling services, buyers have to face complexities such as measuring seller competency and performance. This is very similar to a marketplace for tangible goods wherein a seller is concerned with measuring the creditworthiness of the buyer and the buyer is concerned with measuring the reliability of the stated delivery time of the seller and the seller's history of complaint resolution, as well as other factors.

Collaborative reputation mechanisms are employed to estimate the sellers' performance based on their past transactions, and the process of matchmaking and pricing of the services is automated. The general framework of such a marketplace and of the mechanisms for measuring and estimating the parties' reputations is discussed, for example, in the above-listed patent applications, all of which are hereby incorporated by reference.

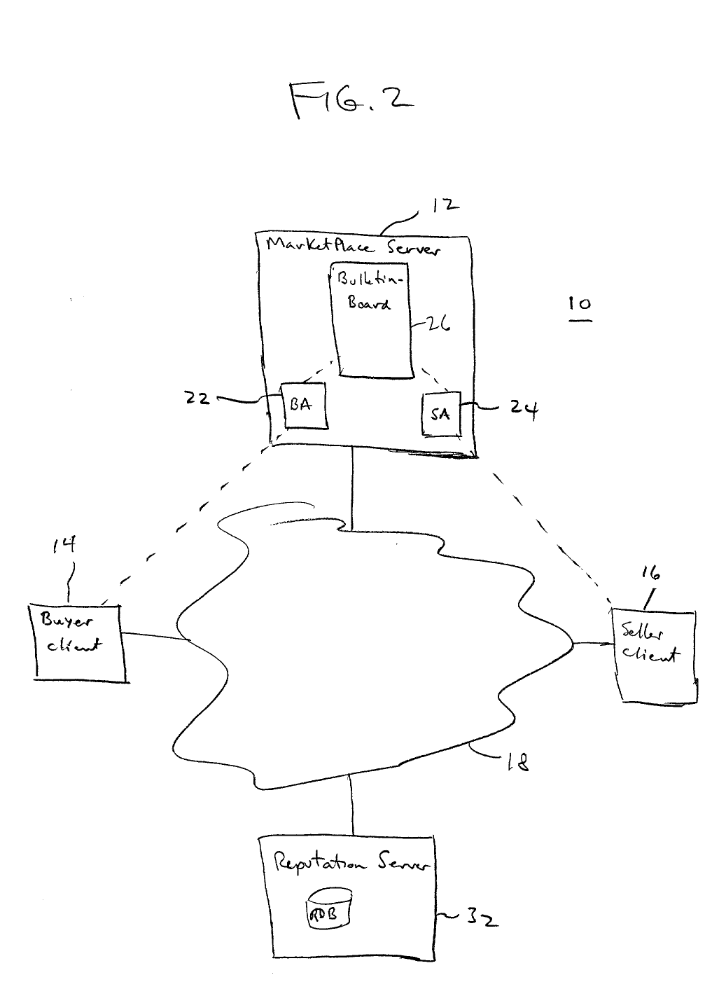

Turning to FIG. 2, there is shown a diagrammatic illustration of a “platform” 10 for an agent-mediated marketplace wherein the present invention may be used. The platform includes a server computer 12, a number of buyer client computers 14 (only one being shown), a number of seller client computers 16 (only one being shown), and the global Internet 18 to interconnect them. The buyer agents and seller agents are software program modules that may reside on any of the computers; for purposes of illustration only, and without any intended loss in generality, buyer agents (BA) 22 and seller agents (SA) 24 are shown as executing on server 12. One or the other of the agents could just as well be shown as executing on a client computer. The server computer or other computer(s) executing the agents (at least the seller agents) receive reputation information from a reputation database (JIB) on a reputation server 32. The reputation server may operate in accordance with any suitable algorithm, including, but not limited to, the various reputation-generating systems of the above-identified co-pending applications. Other software, such as the operating system and an electronic marketplace engine, are not shown in order to avoid obfuscating the invention. The electronic marketplace engine may have various suitable forms. For example, it may be an electronic bulletin board on which buyer agents post their offers to purchase and which buyer agents survey to look for opportunities to do business.

Buyer Agents

The buyers configure their agents with the buyers' budgets and the importance the buyers ascribe to specific tasks (jobs). (This may be done in any convenient way. For example, a web site may be configured on the server computer, with forms for creating and configuring buyer and seller agents. The buyers and sellers may use any Internet-connected client computer to access the web site and set up their agents.) These buyer agents try to maximize their owners' utilities (defined elsewhere herein). In order to achieve this result, the buyer agents estimate the expected performance of each seller based on the reputation of that seller in the marketplace, as well as the sellers' price, and choose the seller that maximizes their expected utility. Selling agents respond to buyers by bidding on behalf of their owners for the available tasks based on their owners' reputations. The reputations of sellers are initially undervalued; only through successful performance will their reputation values improve. That means there is an inherent market inefficiency in this approach. It takes time for sellers to earn good reputations and, thus, be given opportunities to earn good profits. Dynamic pricing algorithms are needed to facilitate opportunities for sellers to succeed. They are also needed to permit sellers to maximize their revenue. Dynamic pricing processes permit transactions to be priced as efficiently as possible by considering the current reputation of each seller.

The equilibria of this marketplace are evaluated for two different scenarios: unemployment (i.e., less demand than supply), and overemployment (i.e., more demand than supply). Since the number of buyers and sellers is kept fixed, the scenarios are created by changing the rate of creation of tasks for each buyer. In particular, we consider the operation of the market over successive defined intervals, or periods, of time. In every period, each buyer has a probability P to generate a problem. Once a problem is generated, the buying agent dispatches a request for bids to all sellers. Upon receipt of this query, all available seller agents respond with a price bid and wait for the buyer's decision. Optionally, if a selling agent is already engaged in another task, it cannot undertake another one, so it does not respond. However, the buying agents may have multiple tasks served at the same time.

After the sellers respond to the buyer, the buyer evaluates the expected utility function for each bid and picks the available seller that offers the highest expected utility. The buyer is allowed to reject all bids. Once the buyer makes its selection, the buyer delegates the task of service completion to (i.e., engages) the chosen seller. Optionally, a seller may become unavailable for some periods in order to perform a delegated task. Tasks may be assumed to take the same amount of time or they may be assigned varying amounts of time. This process is completed for each buyer in the market and, for each buyer, for each transaction that the buyer wishes to complete. After all of the buying and selling bidding activities have been completed for a given period, the process is then repeated for a number of subsequent periods and a record of all contracts established is created, as well as the total “utilities” or services consumed by the buyers and the total profits (and/or revenues) of the sellers. (Note that revenues and profits will mirror each other if the marginal costs are fixed or sellers do not have an incentive to underperform as volume increases.)

At each period, each buyer can generate a “problem” of importance I with probability P. The importance I is a uniformly distributed random variable from 0 to 1. If a problem is generated, the buyer will request bids from the seller without providing information about the importance of the task, so that it does not lose its bargaining power. The sellers, on the other hand, have uniformly distributed abilities A ranging from 0 to 1. The outcomes of all tasks performed by a seller (i.e., the evaluations of their performance) follow a normal distribution. In addition, if the outcome comes out with a mean value that is negative or greater than 1, it is truncated to 0 or 1, respectively. The seller's reputation is updated over time based on the seller's ability, as discussed below.

Consumer-to-consumer marketplaces like Kasbah, MarketMaker, eBay, Yahoo Auctions and Amazon Auctions introduce some major issues of trust. Potential buyers have no physical access to the product or service of interest while they are bidding or negotiating. Therefore, sellers can easily misrepresent the condition or the quality of their products or services. Additionally, sellers or buyers may decide not to abide by the agreement at the electronic marketplace, asking later to renegotiate the price, or even refusing to commit the transaction. Still worse, the buyer may receive the product or service and refuse to pay for it, or the buyer may send payment and the seller may refuse to deliver. Or the delivery may be defective. Also all of these concerns are also true for marketplaces of intangible goods and services, except that instead of the uncertainty about the condition of the products there is uncertainty about the competency or actual Reputation Follower performance of the seller.

One way of addressing such problems is to incorporate into the marketplace a reputation brokering mechanism, so that each user can customize his/her/its pricing strategies according to the risk implied by the reputation values of the counterpart party. Elaborate reputation mechanisms have been developed for open online marketplaces or communities that are robust against common abuses of online rating systems. See, for example, the above-listed patent applications, which are hereby incorporated by reference. After a seller completes a task, the seller's reputation will be updated, using the rating received from the buyer as an indication about the seller's ability. Suppose that at time, t=i, a user with reputation Rᵢ₋₁ is rated with a score Wᵢ, which is a random value normally distributed around the user's ability A, truncated between 0 and 1. Let Eᵢ=Rᵢ₋₁/D, where D is the reputation range. At equilibrium, Eᵢ can be interpreted as the expected value of Wᵢ, which is the ability A of the user, though early in a user's activity it will be an estimate. Let Θ>1 be the effective number of ratings considered in the reputation evaluation. It has been found that Rᵢ may be found from a recursive estimate of the reputation value of a user at time t=i, given the user's most recent reputation, Rᵢ₋₁, and the rating Wᵢ as follows:

$$Equation 4 : {R}_{i} = {R}_{i - 1} + \frac{1}{θ} \cdot Φ ( {R}_{i - 1} ) ( {W}_{i} - {E}_{i} ) ,$$

$$Equation 5 : Φ ( {R}_{i - 1} ) = 1 - \frac{1}{1 + {e}^{\frac{- ( {R}_{i - 1} - D )}{σ}}} ,$$

$$Equation 6 : {E}_{i} = \frac{{R}_{i - 1}}{D}$$

The parameter σ controls the damping function Φ so that the reputations of highly probable users are less sensitive to rating fluctuations. In order for the agents to have no incentive to switch identities, the initial reputation of the agents may be chosen to be minimal; for example, the initial reputation value may be 0.01. The objective of a buying agent is to pick the most suitable seller for a given task. It does so by maximizing its predetermined utility function. A suitable utility function is the Cobb-Douglas utility function:

U=(1−P)^{1-I}O^{I} Equation 7:

where P is the price the buyer will pay normalized by his budget cap (i.e., P=P_{actual}/P_{cap}, where P_{actual} is the actual price to be paid and P_{cap} is the maximum price the buyer is willing to pay) so that it is between 0 and 1; I is the importance of the problem to the buyer, and 0 is the outcome of the problem in the range of 0 to 1, where 1 is a perfect outcome and 0 is the worst possible outcome. This utility function is appropriate because it has properties consistent with two points: (1) for an important problem, the buyer is willing to spend more and (2) for an unimportant problem, the buyer will sacrifice quality for price.

An assumption also may be made that a buyer always has the option to turn to some external market with reputation I, and price Pₘ to solve his problem. If none of the sellers' offers provides a greater utility to the buyer than the traditional (external) market, then the buyer will employ the traditional market in solving his problem.

In order to evaluate the expected utility, a buyer agent may treat the performance of the seller as a deterministic variable, represented by the value of the seller's reputation. Thus, they evaluate their utility functions using the assumption that the outcome, O, is equal to the reputation of the seller which, as noted above, changes over time.

Selling Agents

Selling agents may be of several kinds. Certain basic kinds of selling agents will be discussed as well as some using more advanced dynamic pricing methods, it being understood that the development of increasingly more intelligent selling agents will result in other candidates in the future.

A. Derivative Followers

Derivative Followers (DFs) are selling agents who decide their next bid according to the success of their preceding bid. Therefore, these sellers focus on increasing their prices from one contract to the next so long as they can get the contracts. Likewise, they decrease their bids after having offered a bid and failed to win a contract. An assumption may be made that Derivative Followers increase their bid prices by a fixed step Sᵤₚ multiplied by a random number picked from a uniform distribution with range [0,1] for the next (inertia+l) periods. The random number is different every time the agent offers a bid. Preliminary experiments have shown that the value of the variable inertia does not have much effect on the results because there are no local maxima or minima in the profit landscapes of the Derivative Follower sellers.

If a Derivative Follower fails to receive a contract (i.e., be engaged by the buyer), it will start decreasing its price bids, which with each successive decrease being S_{dn}*random, where “random” denotes the value of a random variable with a uniform distribution in the range [0,1]. In other words, if “idle” represents the number of periods after the inertia time passes, the offer by the Derivative Follower will be given by:

P=LastContractPrice+Sᵤₚ*random₁-S_{dn}*random₂*idle. Equation 8:

The random numbers random, and random₂ are different and both are recomputed each time an offer is made. LastContractPrice is, as implied, the price bid on the last offered contract.

B. Reputation Followers

By contrast with Derivative Followers, Reputation Followers maintain a shadow price Pₛ on which they apply the Derivative Follower algorithm, and would offer the Derivative Follower price if they had perfect reputation information. However, the price they actually offer is the product of the shadow price and the current reputation value of the buyer. That is, P_{O}=P_{S}*R, where P_{O} is the offered price. This algorithm allows the selling agents to respond fist to changes in their reputations. In our experience, Reputation Followers set bids that follow their received reputation patterns (and eventually their actual performance and abilities) better than do the Derivative Followers. In a sense, these Reputation Followers are Derivative Followers but with a step that depends on the seller's reputation, which changes dynamically. Selling agents with low reputation change their prices slowly. Therefore, in the case of unemployment, it can be expected that they will perform better than low reputation Derivative Followers, since they will undercut the latters' offers.

C. Random Sellers

Random Sellers are agents having no pricing or bidding strategies. They just bid random prices. Naturally, these agents do not perform particularly well, but they provide a measure to use for comparison purposes.

The maximum price that the seller can charge is a function of a given reputation R, the available external market price Pm, and the importance I of the proposed transaction. Mathematically, when the foregoing relationships hold true, the maximum price, Pₘₐₓ, can be modeled as:

$$Equation 9 : P max \leq 1 - \frac{( 1 - {P}_{m} )}{{R}^{\frac{I}{1 - I}}}$$

Further, as stated above, a seller initially has a very low reputation. Therefore, at the outset it can only receive low importance jobs. Even if it bid for 0 price, it can only get a contract if the following relationship holds true:

$$Equation 10 : {R}^{I} \geq {( 1 - {P}_{m} )}^{1 - I} ↔ I \leq \frac{log ( 1 - {P}_{m} )}{log ( R ( 1 - {P}_{m} ) )} ,$$

where I is the importance of the job, and R is the initial reputation of the selling agent. This is expected since agents will opt to build reputation, in order to bid actively for a larger share of the contracts.

FIG. 3 depicts the seller's available offer space and shows the range of bids allowed for a seller as his reputation increases. Sellers have a chance of receiving a contract only if they bid below the curve 34 corresponding to their current reputation value. Of course, the bid also must not exceed the importance the buyer attaches to the problem, which the seller does not know when it places its bid.

Several simulations have been conducted to evaluate the behavior of the buying and selling agents and test the above-described simple pricing algorithms in two different market conditions. All of the sellers started with a minimal price, 0.1, so that none had an initial advantage. The Reputation Follower performance of the algorithms may be evaluated based on the profits of each seller as a function of its ability. The pricing algorithms were also evaluated in competition settings. One-third of the agents were assigned to each of the pricing algorithms. In a first simulation, many agents were used (i.e., 100 or more) in order to track their general behavior. Experiments were then conducted with only a few agents, to better track their behavior.

Unemployment

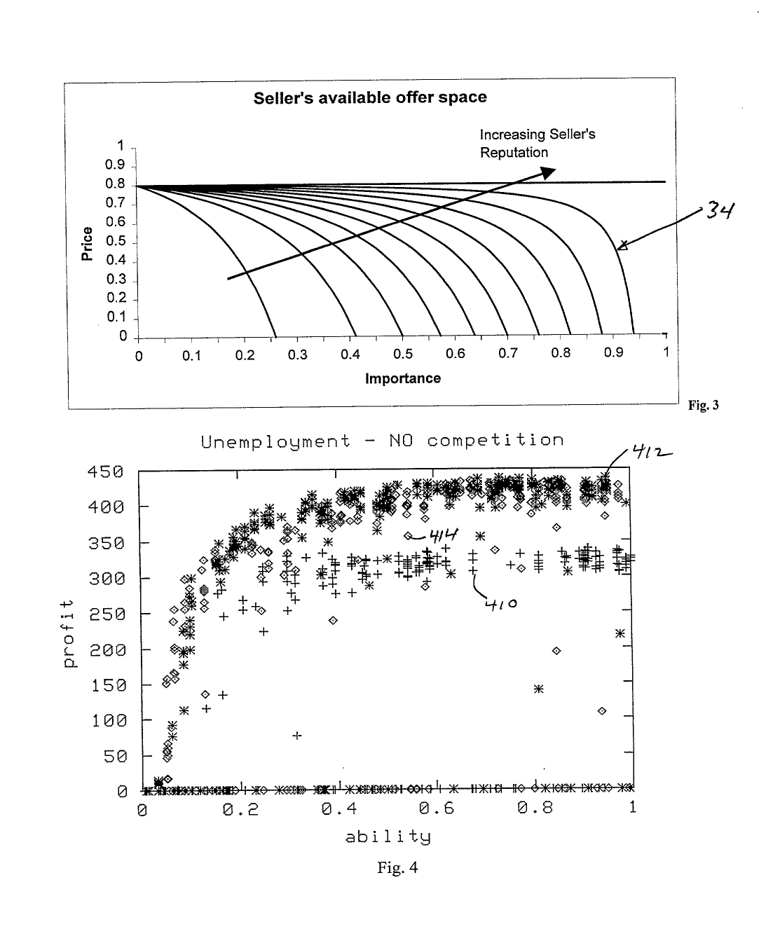

FIG. 4 shows the profits of the sellers obtained in the case where their pricing algorithm is that of a Random Seller 410, denoted by plus signs; a Derivative Follower 412, denoted by asterisks; or a Reputation Follower 414, denoted by diamonds, with no competition among different pricing strategies. As shown, for the unemployment situation, both Followers perform better than Random Sellers, since Random Sellers often set high prices even when they have low reputations. They therefore miss out on winning contracts at a higher rate than followers do. With respect to the two followers, when they observe that they perform about the same, on average. The difference is small.

On the other hand, when the three types of agents compete with each other, as depicted in FIG. 5, then all the agents with more than random intelligence were observed to drive their prices in order to attract the agents of the buyers. Therefore, Random Sellers were not able to get contracts and almost all of them therefore obtained no profit. Further, some followers could not escape from their initial low reputations by offering sufficiently low prices to generate business. That can be attributed to the randomization in following the derivative. Even some agents with very high abilities were not able to engage in trade and could not raise their reputations. Other agents that initially offered lower prices raised their initial reputations and, thus, attracted even more buyers. This is a good example of how initial history might affect such a marketplace with positive reputation mechanisms.

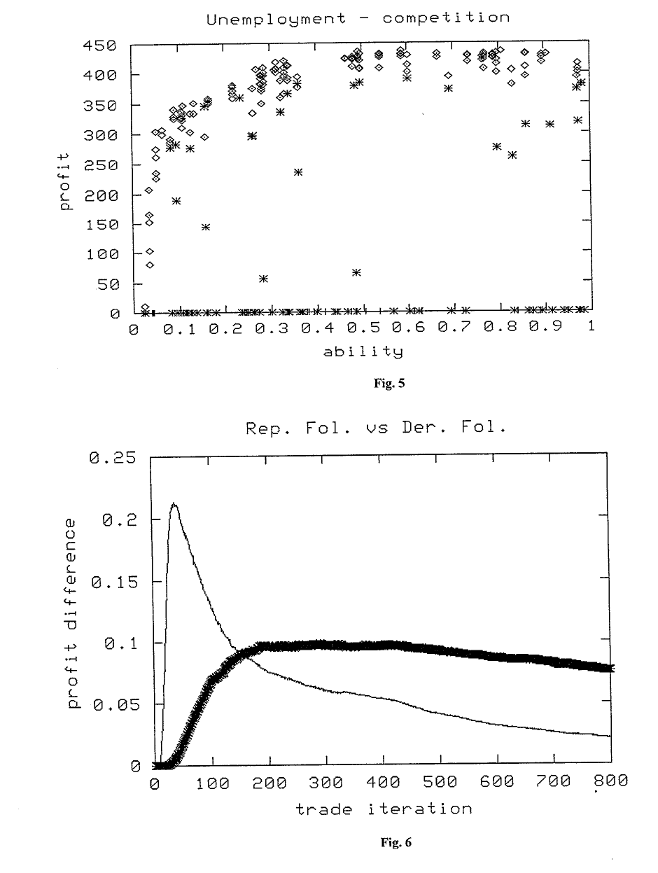

As shown in the drawings, Reputation Followers tend to escape from their initial low reputations more often than did other agent types. This is due to the fact that at the initial states they increase their prices slowly, since their reputations are low, resulting in their bids undercutting those of Derivative Followers and Random Sellers. They (Reputation Followers) consequently increased their profits more than the others. FIG. 6 portrays the average difference between the profits of the Reputation Followers and the Derivative Followers over time. The y-axis values represent the difference in average profit of an RF and a DF divided by the number of trade iterations (i.e., periods), with the x-axis being the number of trade iterations. FIG. 6 shows the difference of profits for two kinds of agents: low ability ones depicted by bold line 612 (in this case, agents with ability less than 0.3 were chosen) and high ability agents depicted by thin line 614 (i.e., agents with ability larger than 0.7). As shown in the figure, at the beginning (i.e., when all agents have low reputations), the difference between the profits of the Reputation Followers and the Derivative Followers increases as a result of the Reputation Followers undercutting the bids of the Derivative Followers most of the time. Over time, this difference decreases; that is, the reputations of the agents that manage to escape the minimum reputation value is the same as their actual ability so both Reputation Followers and Derivative Followers behave similarly. The phenomenon appears for both types of agents, and it is stronger for high ability ones.

Overemployment

Overemployment exists when it is expected that a seller will be “guaranteed” to secure a sales contract. This happens when p*B>q*S, where S is the number of sellers, B is the total number of buyers, p is the probability of a contract (also called a “job”) being created by the buyer, and q is the probability that a seller will bid for the contract. If p*B>S, then the seller can be employed continuously (without having a single period of unemployment) so long as his price offers fall within the acceptable range of the buyers.

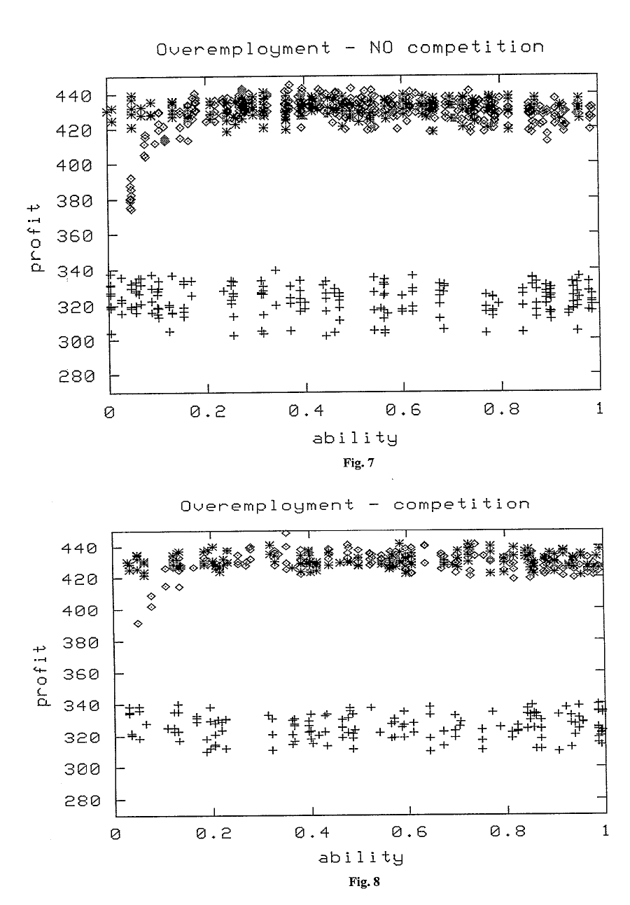

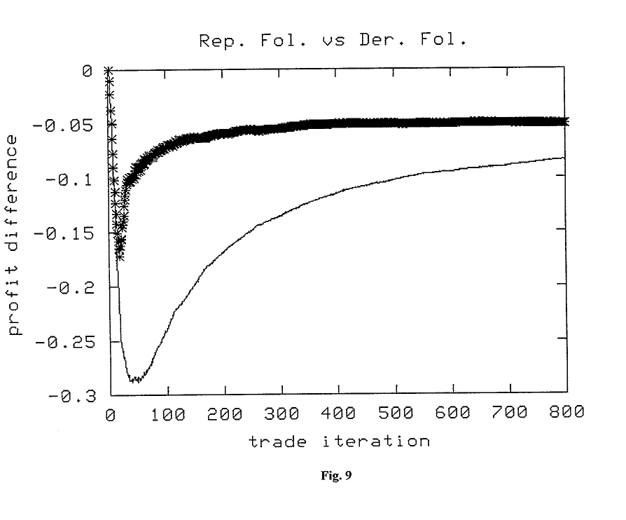

During overemployment, all the sellers have the potential to make significant profits. However, the RFs so not behave very well, as expected, since they do not take advantage of overemployment circumstances. The Reputation Followers perform according to their abilities. The Derivative Followers perform, overall, the best, as shown in FIGS. 7-9 (which parallel the presentations of FIGS. 4-6 and use the same graphical symbols, except that these figures relate to overemployment).

As useful as these approaches are, a more optimal dynamic pricing methodology is proposed.

Assume that there are n sellers and m buyers. The set of sellers will be represented as {S₁, S₂, S₃, . . . , Sₙ}, sorted by their reputations, R(Sᵢ), such that R(S₁)>R(S₂)>R(S₃)>. . . R(Sₙ). The set of buyers will be represented as {B₁, B₂, B₃, . . . , Bₘ}, sorted by quality sensitivity, I(Bⱼ), such that I(B₁)>I(B₂)>I(B₃)>. . . I(Bₘ). Unemployment conditions exist when n>m; full employment, when n=m: and overemployment, when n<m.

Under all conditions, the maximum number of transactions that can take place in each trading period is t=min(n,m). If the sellers know each other's reputations and the buyers' utility functions, it can be shown that there exists a Nash equilibrium in which prices will be such that sellers and buyers will pair according to their respective abilities and quality sensitivities. Trades then will be observed among the following pairs: (S₁, B₁), (S₂, B₂), . . . , (Sₜ, Bₜ).

This equilibrium state does not depend on the dynamics of the reputation algorithm itself. If the reputations of the sellers are stationary, then the optimal pricing strategy would be the one that would price as close as possible to the optimal prices derived above, at every trading period. However, since reputations are allowed to change dynamically, and do change in a real commercial situation, the dynamic pricing algorithms used by the agents also need to adapt to these changes. Further, one may assume that, in fact, sellers do not have complete information.

To evaluate how socially optimal the different dynamic pricing strategies are, we may compare their efficiencies with the control case of sellers having perfect information about the marketplace dynamics. This perfect information includes the numbers of sellers and buyers, the reputations of all sellers, and the importance distributions of all the buyers. Although it is unrealistic that a system ever would include such Optimal Strategy Sellers, they provide a good benchmark for evaluating the intelligence and the social efficiency of a dynamic pricing algorithm.

The Optimal Strategy sellers would utilize all the information available to them in order to price according to the Nash Equilibrium described above. As further explained above, the reputations of the sellers affect their overall profits mostly in unemployment environments, where only the most reputable sellers will make transactions at equilibrium. Fly contrast, in overemployment environments, all such sellers will make transactions at equilibrium with reputation-independent prices. Thus, attention will now be focussed on unemployment environments.

In the case of unemployment, the Optimal Sellers will behave as follows: All sellers know that seller t+1 can try to undercut them by offering its services at minimal prices. Therefore, all sellers will have to match the utility offered by the t+1^{st} seller when that sellers bids P₀ (=0.1). Consequently the optimal price for each seller would be such that:

$$Equation 11 : \\ U ( {B}_{j} ) = {( 1 - {P}_{0} )}^{1 - I ( {B}_{j} ) {R}_{t + 1}^{I ( {B}_{j} )}} = {( 1 - P ( {S}_{j} ) )}^{1 - I ( {B}_{j} )} {R}_{j}^{I ( {B}_{j} )} = > P ( {S}_{j} ) = 1 - {[ \frac{{( 1 - {P}_{0} )}^{1 - I ( {B}_{j} )} {R}_{t + 1}^{I ( {B}_{j} )}}{{R}_{J}^{I ( {B}_{j} )}} ]}^{1 / 1 - I ( {B}_{j} )}$$

We now turn to some experiments comparing the optimal sellers with the Derivative and Reputation Followers.

Experimental Comparison with Optimal Sellers

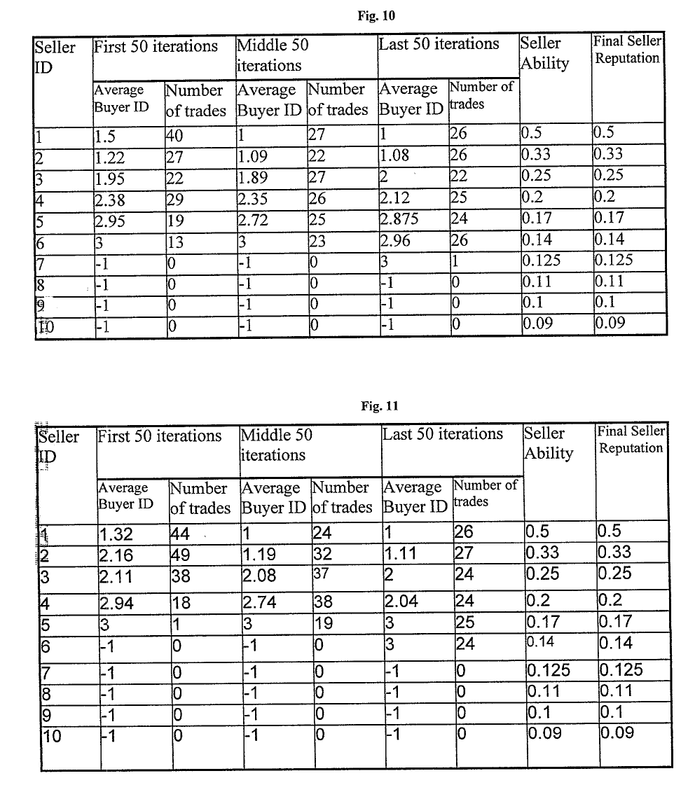

To observe more closely the behavior of the agents, experiments were run with a few of them. In a first experiment, three buyers and ten sellers were used and the probability P of each buyer generating a task was set at unity. This permitted easier tracking of the matching of buyers and sellers. For simplicity, without loss of generality, the importance sensitivities I of the buyers were fixed: buyer B₁ had I equal to 0.707; B₂, 0.577; and B₃, 0.5. Thus the importance decreasing with increasing buyer identification index number. At the beginning, seller reputations were fixed, as well. Their reputations were equal to their abilities, which were also a decreasing function of their identification indices, shown at the two right-most columns of FIGS. 10 and 11. All sellers started with prices equal to 0.1, the minimum possible price they can charge. FIGS. 10 and 11 show the equilibrium reached for derivative and Reputation Followers. The first column is the seller identification index (sellers S₁ through S₁₀); the second and third columns show the average buyer identification index with whom each seller traded the first 50 iterations (−1 if the seller made no trades), and the total number of trades made by each seller during these iterations. For example in FIG. 10, seller S₁ traded with “buyer” B_{1.5} (this is simply the arithmetic average of the identification indices of the buyers with whom seller S₁ trades), and had a total of forty trades. Seller S₆ traded only with buyer B₃ a total of thirteen trades. Similarly, the fourth and fifth columns show the average buyer identification index and total number of trades during iterations 100-150; and the sixth and seventh columns, the same for iterations 750-800.

According to the derivation above, the Optimal Sellers with complete information would trade as follows: seller S₁ would trade with buyer B₁, seller S₂ with buyer B₂, seller S₃ with buyer B₃, and sellers S₄-S₁₀ would not trade. Instead of reaching this theoretical equilibrium, it was noticed that both Derivative Followers and Reputation Followers (FIG. 10 and FIG. 11, respectively) reach an “equilibrium” where sellers S₁ and S₂ “share” buyer B₁ (half of the times seller S₁ trades with buyer B₁, and seller S₂ does not trade, and the other half of the times seller S₂ trades with buyer B₁ and seller S₁ does not trade), sellers S₃ and S₄ “share” buyer B₂, sellers S₅ and S₆ “share” buyer B₃, and sellers S₇ through S₁₀ do not trade. Notice that this equilibrium is not reached the first 50 iterations, and it is almost reached in 100 iterations (the fourth and fifth columns are similar to the sixth and seventh columns, respectively). The final prices charged by the sellers also are reported, to compare with the theoretically optimal ones given by Equation 11. Equation 11 gives that seller S₁ should price its bid at 0.901479; seller S₂, 0.552088: seller S₃, 0.28; and sellers S₄-S₁₀ 0.1. Instead at the equilibrium reached the Derivative and Reputation Followers charge similar prices as follows: seller S₁, 0.919175; seller S₂, 0.767465; seller S₃, 0.542694; seller S₄, 0.36816; seller S₅, 0.229084; seller S₆, 0.102303, and sellers S₇ through S₁₀, 0.1.

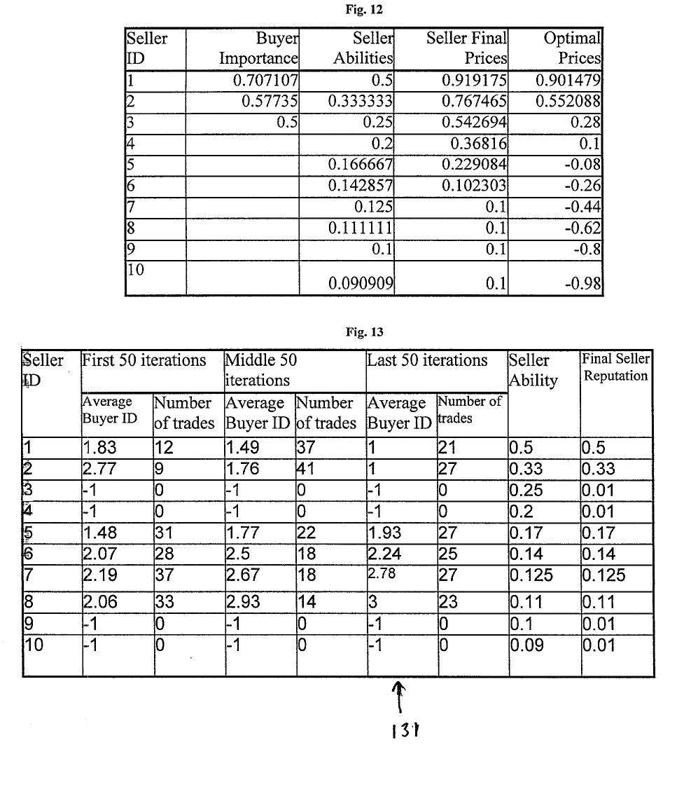

In further experiments, reputations were changed dynamically, to study the equilibrium reached. The results are shown in FIGS. 12 and 13. It is interesting to observe that the equilibrium reached by both types of sellers is the same as before, except that now the “rank” of the sellers is not based on their actual abilities, but on their reputations. Moreover, for Reputation Followers the final reputations of the sellers coincide with their true abilities, so the equilibrium reached is similar to that in FIGS. 10 and 11. On the other hand, Derivative Followers reach different reputations and therefore different equilibria: in FIG. 13, column 131 has many −1's mixed with normal identification indices, but the identifications that are not −1 are still decreasing, with the final sellers' reputations shown in the last column. In the general case of dynamically changing reputations, it is important that the dynamic pricing methods lead to equilibria that not only agree with the theoretical one according to the reputations of the sellers, but also that the sellers' reputations coincide with their actual abilities.

Profit Maximizing Reputation Followers

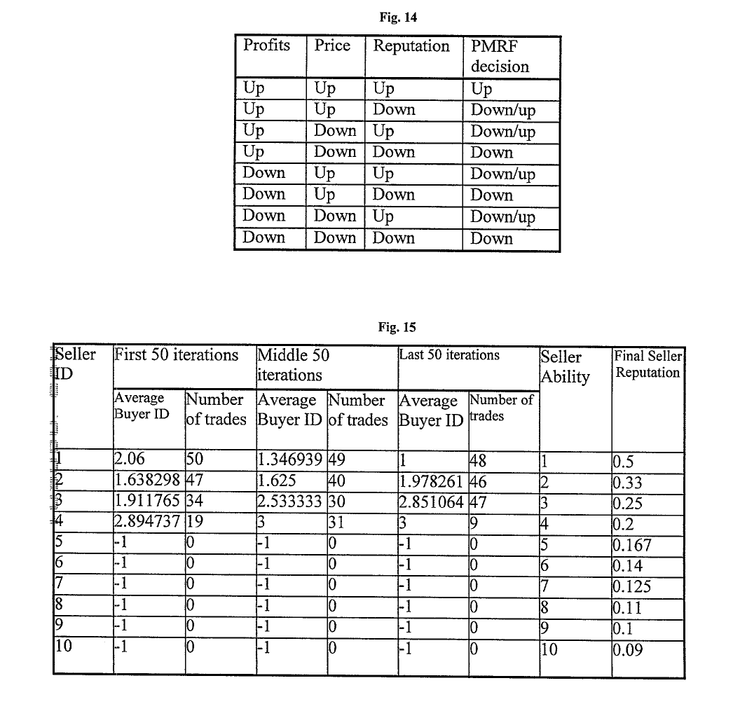

The results described above show that the Derivative Followers under-perform in cases of changing reputations, because their equilibrium prices do not match the seller's abilities. They are trapped in local maximum hills of their profit landscapes and they optimize their pricing for buyers of lesser quality sensitivities than the ones that match their abilities. On the other hand, reputation followers manage to have their reputations match their abilities, but they suffer from the same problem that both derivative followers and reputation followers have in the case of fixed reputations: the equilibrium reached is not the same as the theoretical one. Instead, the sellers oscillate their prices, optimizing for two consecutive buyers rather than one the same ranking of quality sensitivity (i.e., buyers B₁, B₂ and B₃ buy from sellers (S₁,S₂), (S₃,S₄), and (S₅,S₆), instead of S₁, S₂ and S₃). Therefore, we need a pricing mechanism that allows the sellers to escape from local maxima and learn the optimal prices for their abilities. For this purpose dynamic pricing sellers have been designed that not only take into account their prices and reputations, but also their profits; they also compare prices, profits, and reputations over a period of time so that, in a sense, they have “memory” of the past. In particular the profit followers with memory behave as follows: for a given time window, say of length of 10 iterations, they measure their average prices, profit, and reputation over the most recent 10 iterations and of the previous 10 iterations (i.e., from 20 iterations ago until 10 iterations ago). They then decide their next price bid based on the relative changes of their reputation, prices, and profits over these two periods. For example, if the profits, the prices, and the reputations increased relative to their values from 20 to 10 iterations ago, the agents further increase their prices. If the profits decreased while the prices increased and the reputations decreased, they decrease their next price. The decision logic of, and hence the actions taken by, these agents under all market circumstances are set forth in FIG. 14. For the cases that it is not clear whether to increase or decrease the price, the agents choose the average price of the past 2t iterations. These agents are referred to as Profit Maximizing Reputation Followers (PMRFs). In the four cases where the decision is ambiguous, the PMRF agents implement a divide and conquer approach, by choosing the mean of the average price during the two consecutive periods.

A more optimal value than the mean may be selected, based on the incremental impact of prices and reputations on the buyers' perceived utilities. Such an approach requires that the sellers maintain a model for the utility functions of the buyers.

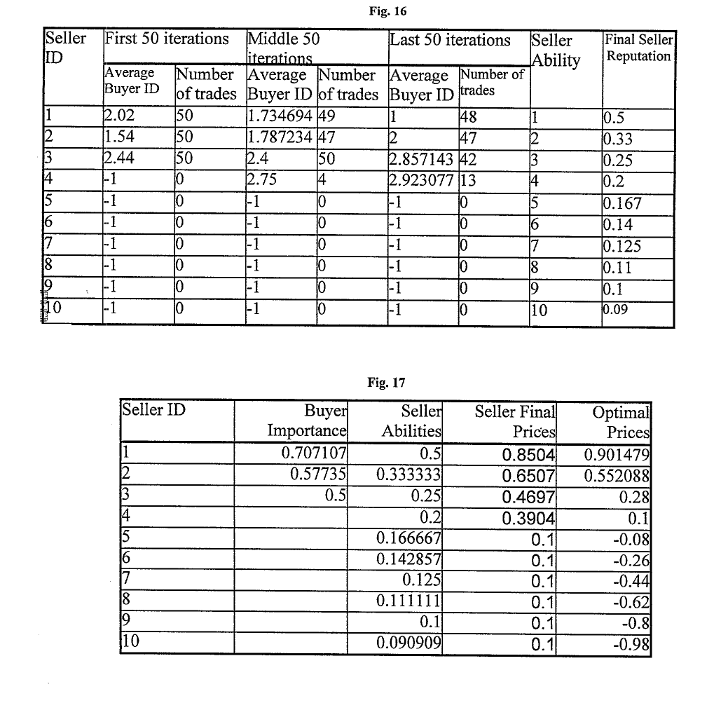

The results of simulations using profit followers with memory are recorded in Figs. FIGS. 15-17. FIG. 15 shows the equilibrium results with stationary reputations, and FIGS. 16 and 17 show the equilibrium results with changing reputations. As one can see from both FIGS. 15 and 16, the sellers end up optimizing their pricing in order to trade with their respective buyers, in both the experiments with stationary, and non stationary reputations. FIG. 17 shows that the final seller prices are slightly higher than the optimal for all the sellers who are able to make transactions except the first one.

Effectuating a Transaction

Referring back to FIG. 2, it will now be appreciated that a contract between a buyer and a seller may be formed as follows: Buying agents 22 post to a bulletin board 26 on server 12 a list of services they desire to purchase, along with the related conditions. Conditions may be expressed by completing a web form supplied by the server. The form may include check boxes, pull down menus and the like, to facilitated automated matching to a seller's offerings, and perhaps may also include a text field for other comments. Pull down menus and check boxes can be based on an ontology compiled by the marketplace operator to address the appropriate service descriptions for a particular field or fields. The same ontology would be used by the sellers to express their competencies and for the buyers to express services desired when the respective agents are created or modified. Sellers' agents scan the listings from the buyers looking for listings on which to submit bids. When a seller agent finds a suitable listing matching its abilities, it submits a bid, provided that it can do so while still generating a profit for the seller (a break-even limit having been established by the seller when it set up its agent). Buyers (i.e., their agents) evaluate the sellers' reputations against their own minimum requirements, if any, and evaluate the bids of acceptable sellers to determine if there is one to accept. If a buyer accepts a bid, it sends a message to the seller so indicating. Typically, it is the responsibility of the seller to notify the marketplace operator for the purpose of fulfilling a contract to pay a fee to the operator. The seller then reviews its inventory to determine whether fulfilling the contract will use up its available resources (abilities), in which case it must make itself unavailable to bid on buyer offers to purchase that it would be unable to fulfill. (Otherwise, if the seller overcommits, it is committing commercial suicide because the buyer will be disappointed and provide a low rating to the reputation service provider. Preferably, after each transaction has been completed, the reputation server sends the buyer a questionnaire and obtains performance rating responses which can then be used to augment and update the reputation report on the seller.) If the contract calls for delayed delivery of services, the period of unavailability, if any, may not begin immediately.

Having thus explained the inventive concepts and illustrative implementations thereof, including buying and selling agents and a marketplace for them to interact, it will be clear that such illustrative implementations were presented by way of example only, and not to be exclusive or limiting in any fashion. Various alterations, additions and deletions will now readily occur to those skilled in the art and it is intended that this disclosure be understood as suggesting such modifications. For example, in the illustrations it has been assumed that the sellers incur fixed marginal costs and that they have the same cost and profit structure for all services (or goods) delivered, so that their profits will therefore be maximized by increasing revenue. Indeed, multiple levels of quality of offering may be established, each with its own profit structure. A seller agent designed to maximize profit for the seller would then require an additional algorithm to make decisions among the posted buyer offers to purchase. A seller with a high reputation value may be able to pass up offers to purchase low quality services in favor of an offer to purchase high quality services that generate more profit.

Also, in the examples, only a scalar reputation value was assumed. Indeed, however, reputation may be multi-dimensional, such that a vector representation is more appropriate. For example, if a seller offers three tiers of quality, separate reputation values for each tier would make sense. Also, different aspects of performance might warrant separate values, such as a value for timeliness, a value for quality, and a value for responsiveness. Buyers could then specify minimum value requirements for each reputation component category when seeking out acceptable sellers.

Accordingly, the invention is limited only as required by the appended claims and equivalents thereto.

What is claimed is:

1. A seller's agent for use in an agent-mediated marketplace, the seller's agent using a profit maximizing reputation follower strategy to set a bid price for responding to a buyer's offer to purchase, and responsive to seller reputation information.

2. The seller's agent of claim 1 wherein the reputation information provides reputation for all sellers bidding in response to the buyer's offer.

3. The seller's agent of claim 1 or claim 2 wherein, in response to wining a contract with a buyer' agent, the seller's agent evaluates its resulting abilities and withdraws from bidding on any further buyers' offers it will not be able to satisfy as a result of the contractual demands on the seller until the contract has been completed and the seller's associated resources are again available.

4. A method for a seller's agent to formulate a bid price in response to a buyer's offer to purchase via an agent-mediated marketplace, comprising:
examining the buyer's offer;
receiving information about the seller's reputation and the reputations of other sellers of services requested by the buyer; and
based on the buyer's offer, the reputation information, and the seller's history of success, formulating a bid price and conveying the bid price to the buyer.

5. A system for effecting electronic contracts between buyers and sellers, comprising:
a plurality of seller agents;
a plurality of buyer agents;
a marketplace server; and
a seller reputation data source;
the buyer agents placing on the marketplace server offers to purchase;
the seller agents evaluating the offers to purchase and selectively making a bid to meet an offer when a seller has the ability to do so, a price included in the bid being based at least in part on a seller reputation value obtained from the seller reputation data source.

6. The system of claim 5 wherein the buying agents evaluate bids from sellers at least in part in consideration of seller reputation values from the seller reputation data source, a seller's price bid and an importance the buying attaches to the purchase.

7. The system of claim 5 or claim 6 wherein the selling agents use a reputation follower strategy to set a bid price.

8. The system of claim 7 wherein the reputation follower strategy is a profit maximizing reputation follower strategy.
